(19) United States
(12) Patent Application Publication
(10) Pub. No.: US 2026/0259852 A1
(43) Pub. Date: Sep. 3, 2026

(54) DIRECT BROADCASTING OF CALCULATED SUMS BETWEEN ACCUMULATORS IN A MULTI-CORE SPATIAL ARCHITECTURE

(71) Applicants: XILINX, INC., San Jose, CA (US); Advanced Micro Devices, Inc., Santa Clara, CA (US)

(72) Inventors: Gagandeep SINGH, Zurich (CH); Kristof DENOLF, Longmont, CO (US)

(21) Appl. No.: 19/069,005

(22) Filed: Mar. 3, 2025

(51) Int. Cl. G06F 15/80; G06F 9/54

(52) U.S. Cl. CPC G06F 15/80; G06F 9/54; G06F 2209/543

(57) ABSTRACT

An accumulator broadcast network is described that permits an accumulator in one core of a multi-core IC to transmit high-precision data to accumulators in multiple cores in parallel. That is, instead of a sending data to local memory and the broadcasting to different cores using shared memory or messaging protocols, the data stored in the accumulator registers can be directly transmitted to other accumulators.

### TECHNICAL FIELD

Examples of the present disclosure generally relate to broadcasting data from an accumulator register in one processing core to accumulators in other cores.

### BACKGROUND

Multi-core integrated circuits (IC) often have their own multiply-accumulate (MAC) units formed from multiplication circuits and accumulators. Because these accumulators often perform multiple iterations, their registers may store much larger (or precise) data than other registers in the core. For example, when performing a MAC operation on 8-bit integers (INT8), the accumulator registers may store data using 32 bits. Once completed, the high-precision 32 bit value may be rounded or shifted (i.e., back to an INT8) before being saved in other registers in the core. This lower precision value can then be transmitted to other cores in the IC.

### SUMMARY

An integrated circuit (IC) is described in some embodiments. The IC includes an array of data processing engines (DPEs), each comprising a core, and each of the cores comprises an accumulator. The IC also includes an accumulator broadcast network comprising direct core-to-core links that interconnect the accumulators in the cores. Moreover, a first core of the cores is configured to use the accumulator broadcast network to transmit accumulator data to multiple cores in parallel.

A method includes configuring an accumulator broadcast network in an IC that includes an array of data processing engines (DPEs), each comprising a core, and each of the cores includes an accumulator. Moreover, the accumulator broadcast network includes direct core-to-core links that interconnect the accumulators in the cores. The method also includes synchronizing a first core of the cores to multiple cores of the cores and broadcasting accumulator data from the first core to the multiple cores in parallel using the accumulator broadcast network.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a hardware accelerator array, according to an example.

FIG. 2 is a block diagram of a data processing engine, according to an example.

FIG. 3 is a block diagram of an accumulator broadcast network, according to an example.

FIG. 4 is a block diagram of connections between accumulators in different cores, according to an example.

FIG. 5 is a flowchart of a communicating directly between accumulators in different cores, according to an example.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe an accumulator broadcast network that permits an accumulator in one core of a multi-core IC to transmit high-precision data to accumulators in multiple cores in parallel. That is, instead of a sending data to local memory and then broadcasting the data to different cores using shared memory or messaging protocols, the data stored in the accumulator registers can be directly transmitted to other accumulators. This avoids latency and overhead from using indirect techniques such as local memory or messaging protocols.

Further, the data can be transmitted in a high precision state rather low precision state, which is the case when using indirect techniques. This is especially advantageous for a workload that is distributed between multiple accumulators in different cores. For example, a first accumulator may be tasked with performing a first portion of a MAC operation while second and third accumulators on different cores are tasked with performing the remaining portions of the MAC operation. Using the accumulator broadcast network, the first accumulator can transmit the high precision (intermediate) data directly to the second and third accumulators, rather than having to round or shift the data in order to transmit the data using an indirect technique. This preserves (or increases) data accuracy for the distributed MAC operation.

In one embodiment, the accumulator broadcast network can include hardware such as switches (e.g., switchboxes or a plurality of multiplexors) that can be configured at compile time or runtime to broadcast the data. Each core can include one or more switches to route accumulator data along a row and/or a column of an array of cores in an IC. However, in another embodiment, the accumulator broadcast network can be software enabled where software executing on the cores can use processing cycles to forward accumulator data to neighboring cores.

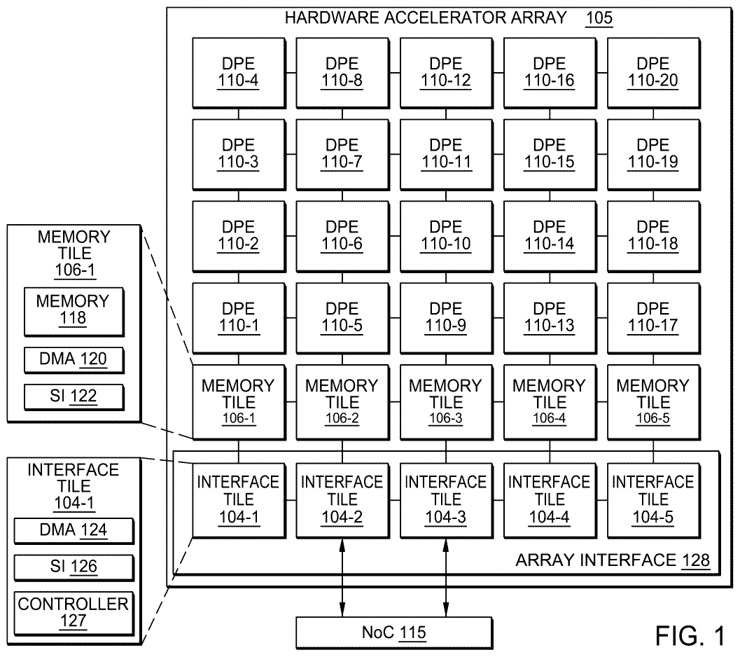

FIG. 1 is a block diagram of a hardware accelerator array 105, according to an example. In this example, the hardware accelerator array 105 includes a plurality of circuit blocks, or tiles, illustrated here as the DPEs 110 (also referred to as DPE tiles or compute tiles), interface tiles 104, and memory tiles 106. Memory tiles 106 may be referred to as shared memory and/or shared memory tiles. Interface tiles 104 may be referred to as shim tiles, and may be collectively referred to as an array interface 128. The hardware accelerator array 105 is coupled to a NoC 115, which couples the array 105 to other components in the same IC (or same SoC) such as a CPU, graphics processing unit (GPU), memory controller, and the like. FIG. 1 further illustrates that the interface tiles 104 communicatively couple the other tiles in the hardware accelerator array 105 (i.e., the DPEs 110 and memory tiles 106) to the NoC 115.

DPEs 110 can include one or more processing cores, program memory (PM), data memory (DM), DMA circuitry, and stream interconnect (SI) circuitry. For example, the core(s) is the DPEs 110 can execute program code stored in the PM. The core(s) may include, without limitation, a scalar processor and/or a vector processor. DM may be referred to herein as local memory or local data memory, in contrast to the memory tiles 106 which have memory that is external to the DPE tiles, but still within the hardware accelerator array 105.

The core(s) in the DPEs 110 may directly access data memory of other DPE tiles via DMA circuitry. The core(s) may also access DM of adjacent (or neighboring) DPEs 110 via DMA circuitry and/or DMA circuitry of the adjacent compute tiles. In one embodiment, DM in one DPE 110 and DM of adjacent DPE tiles may be presented to the core(s) as a unified region of memory. In one embodiment, the core(s) in one DPE 110 may access data memory of non-adjacent DPEs 110. Permitting cores to access data memory of other DPE tiles may be useful to share data amongst the DPEs 110.

The hardware accelerator array 105 may include direct core-to-core cascade connections amongst DPEs 110. Direct core-to-core cascade connections may include unidirectional and/or bidirectional direct connections. Core-to-core cascade connections may be useful to share data amongst cores of the DPEs 110 with relatively low latency (e.g., the data does not traverse stream interconnect circuitry, and the data does not need to be written to data memory of an originating DPE and read by a recipient or destination DPE). For example, a direct core-to-core cascade connection may be useful to provide results from an accumulation register of a processing core of an originating DPE directly to a processing core(s) of a destination DPE.

In an embodiment, DPEs 110 do not include cache memory. Omitting cache memory may be useful to provide predictable/deterministic performance. Omitting cache memory may also be useful to reduce processing overhead associated with maintaining coherency among cache memories across the DPEs 110.

In an embodiment, processing cores of the DPE 110 do not utilize input interrupts. Omitting interrupts may be useful to permit the processing cores to operate uninterrupted. Omitting interrupts may also be useful to provide predictable and/or deterministic performance.

One or more DPEs 110 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 110, or a subset thereof, are substantially identically to one another (i.e., homogenous compute tiles). Alternatively, one or more DPEs 110 may differ from one other more other DPEs 110 (i.e., heterogeneous compute tiles).

Memory tile 106-1 includes memory 118 (e.g., random access memory or RAM), DMA circuitry 120, and stream interconnect (SI) circuitry 122.

Memory tile 106-1 may lack or omit computational components such as an instruction processor or a core. In an embodiment, memory tiles 106, or a subset thereof, are substantially identical to one another (i.e., homogenous memory tiles). Alternatively, one or more memory tiles 106 may differ from one other more other memory tiles 106 (i.e., heterogeneous memory tiles). A memory tile 106 may be accessible to multiple DPEs 110. Memory tiles 106 may thus be referred to as shared memory.

Data may be moved between/amongst memory tiles 106 via DMA circuitry 120 and/or stream interconnect circuitry 122 of the respective memory tiles 106. Data may also be moved between/amongst data memory of a DPE 110 and memory 118 of a memory tile 106 via DMA circuitry and/or stream interconnect circuitry of the respective tiles. For example, DMA circuitry in a DPE 110 may read data from its data memory and forward the data to memory tile 106-1 in a write command, via stream interconnect circuitry in the DPE 110 and stream interconnect circuitry 122 in the memory tile 106. DMA circuitry 124 of memory tile 106-1 may then write the data to memory 118. As another example, DMA circuitry 120 of memory tile 106-1 may read data from memory 118 and forward the data to a DPE 110 in a write command, via stream interconnect circuitry 122 and stream interconnect circuitry in the DPE 110, and DMA circuitry in the DPE 110 can write the data to its data memory.

Array interface 128 interfaces between the hardware accelerator array 105 (e.g., DPEs 110 and memory tiles 106) and the NoC 115. Interface tile 104-1 (also referred to as a shim tile) includes DMA circuitry 124, stream interconnect circuitry 126, and a controller 127. Interface tiles 104 may be interconnected so that data may be propagated amongst interface tiles 104 bi-directionally. An interface tile 104 may operate as an interface for column of DPEs 110 (e.g., as an interface to the NoC 115). Interface tiles 104 may be connected such that data may propagate from one interface tile 104 to another interface tile 104 bi-directionally.

In an embodiment, interface tiles 104, or a subset thereof, are substantially identically to one another (i.e., homogenous interface tiles). Alternatively, one or more interface tiles 104 may differ from one other more other interface tiles 104 (i.e., heterogeneous interface tiles).

In an embodiment, one or more interface tiles 104 are configured as a NoC interface tile (e.g., as primary and/or secondary device) that interfaces between the DPEs 110 and the NoC 115 (e.g., to access other components in the SoC). While FIG. 1 illustrates coupling a subset of the interface tiles 104 to the NoC 115, in one embodiment, each of the interface tiles 104-1-5 is connected to the NoC 115. Doing so may permit different applications to control and use different columns of the memory tiles 106 and DPEs 110.

The controllers 127 in each of the interface tiles 104 can program or configure the DMA circuitry and stream interconnect circuitry of the hardware accelerator array 105 to provide desired functionality and/or connections to move data between/amongst DPEs 110, memory tiles 106, and the NoC 115. This enables the DPEs 110 to perform a desired operation (e.g., a ML function). The DMA circuitry and stream interconnect circuitry of the hardware accelerator array 105 may include, without limitation, switches and/or multiplexers that are configurable to establish signal paths within, amongst, and/or between tiles of the hardware accelerator array 105. The hardware accelerator array 105 may further include configurable Advanced eXtensible Interface (AXI) AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 110 configure the DMA circuitry and stream interconnect circuitry of the respective DPEs 110 based on core code stored in PM of the respective DPEs 110. The controllers 127 in each column can configure DMA circuitry and stream interconnect circuitry of memory tiles 106 and interface tiles 104 in that particular column based on controller code. Moreover, in one embodiment, the controllers 127 in each column can configure DMA circuitry for the DPEs 110 in their respective columns.

While FIG. 1 illustrates a controller 127 per column, there may be other arrangements where multiple controllers are tasked with controlling different subsets of tiles in the hardware accelerator. For example, the array may include a controller in every other column, where each controller is tasked with controlling tiles in two columns. In another example, there may be multiple controllers per column where each controller is tasked with controlling a different subset of tiles within the column.

In one embodiment, the controllers 127 are microprocessors. The controllers 127 can be hardened circuitry that executes software code (or firmware) that controls the DPE. In one embodiment, the only task of the controllers 127 is to control and orchestrate the functions performed by the array 105. However, in other embodiments, other tasks may be performed by the controllers 127, such as moving data into and out of the array 105 using the NoC 115. For example, the controllers 127 may communicate with a memory controller (not shown) to store data in, or retrieve data from, the memory (either in the same IC as the array 105 or on a different IC). In this example, the controllers 127 may execute different specialized code depending on the task a CPU has currently assigned to the array 105.

The hardware accelerator array 105 may include a hierarchical memory structure. For example, data memory of the DPEs 110 may represent a first level (L1) of memory, memory 118 of memory tiles 106 may represent a second level (L2) of memory, and external memory outside the hardware accelerator array 105 may represent a third level (L3) of memory. Memory capacity may progressively decrease with each level (e.g., memory 118 of memory tile 106 may have more storage capacity than data memory in the DPEs 110, and external memory may have more storage capacity than data memory 118 of the memory tiles 106). The hierarchical memory structure is not, however, limited to the foregoing examples.

As an example, in an artificial intelligence (AI) application, an input tensor may be relatively large (e.g., 1 megabyte or MB). Local data memory in the DPEs 110 may be significantly smaller (e.g., 64 kilobytes or KB). The controller 127 may segment an input tensor and store the segments in respective blocks of shared memory tiles 106.

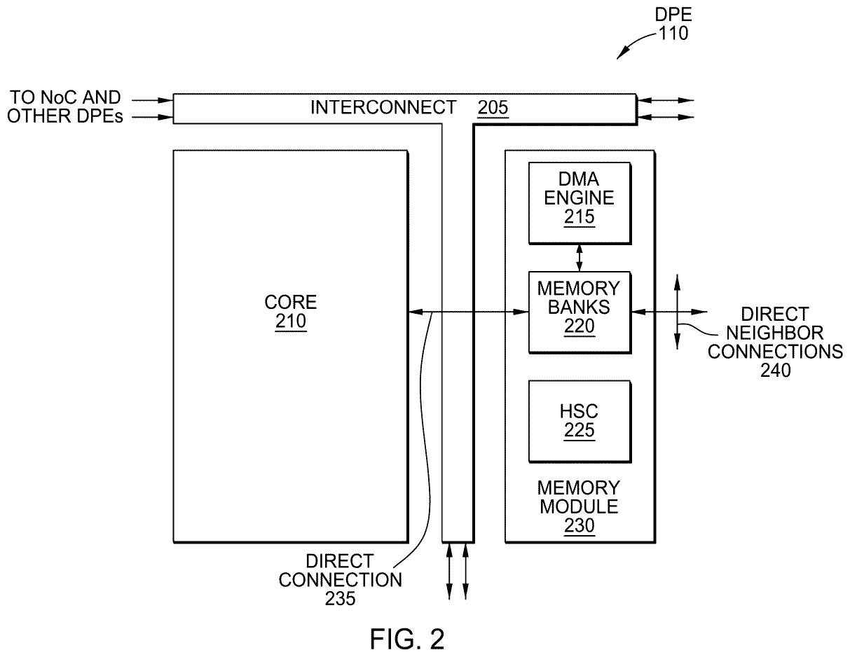

FIG. 2 is a block diagram of a DPE, according to an example. In this example, FIG. 2 illustrates one implementation of the DPE 110 in the hardware accelerator array 105 illustrated in FIG. 1, according to an example. The DPE 110 includes an interconnect 205, a core 210, and a memory module 230. The interconnect 205 permits data to be transferred from the core 210 and the memory module 230 to different cores in the array. That is, the interconnect 205 in each of the DPEs 110 may be connected to each other so that data can be transferred north and south (e.g., up and down) as well as east and west (e.g., right and left) between the DPEs 110 in the array.

For example, the DPEs 110 in an upper row of the array rely on the interconnects 205 in the DPEs 110 in a lower row to communicate with the NoC 115 shown in FIG. 2. For example, to transmit data to the NoC, a core 210 in a DPE 110 in the upper row transmits data to its interconnect 205 which is in turn communicatively coupled to the interconnect 205 in the DPE 110 in the lower row. The interconnect 205 in the lower row is connected to the NoC. The process may be reversed where data intended for a DPE 110 in the upper row is first transmitted from the NoC to the interconnect 205 in the lower row and then to the interconnect 205 in the upper row that is the target DPE 110. In this manner, DPEs 110 in the upper rows may rely on the interconnects 205 in the DPEs 110 in the lower rows to transmit data to and receive data from the NoC.

In one embodiment, the interconnect 205 includes a configurable switching network that permits the user to determine how data is routed through the interconnect 205. In one embodiment, unlike in a packet routing network, the interconnect 205 may form streaming point-to-point connections. That is, the streaming connections and streaming interconnects (not shown in FIG. 2) in the interconnect 205 may form routes from the core 210 and the memory module 230 to the neighboring DPEs 110 or the NoC. Once configured, the core 210 and the memory module 230 can transmit and receive streaming data along those routes. In one embodiment, the interconnect 205 is configured using the AXI Streaming protocol. However, when communicating with the NoC, the DPEs 110 may use the AXI memory mapped (MM) protocol.

In addition to forming a streaming network, the interconnect 205 may include a separate network for programming or configuring the hardware elements in the DPE 110. Although not shown, the interconnect 205 may include a memory mapped interconnect (e.g., AXI MM) which includes different connections and switch elements used to set values of configuration registers in the DPE 110 that alter or set functions of the streaming network, the core 210, and the memory module 230.

In one embodiment, streaming interconnects (or network) in the interconnect 205 support two different modes of operation referred to herein as circuit switching and packet switching. In one embodiment, both of these modes are part of, or compatible with, the same streaming protocol-e.g., an AXI Streaming protocol. Circuit switching relies on reserved point-to-point communication paths between a source DPE 110 to one or more destination DPEs 110. In one embodiment, the point-to-point communication path used when performing circuit switching in the interconnect 205 is not shared with other streams (regardless of whether those streams are circuit switched or packet switched). However, when transmitting streaming data between two or more DPEs 110 using packet-switching, the same physical wires can be shared with other logical streams.

The core 210 may include hardware elements for processing digital signals. For example, the core 210 may be used to process signals related to wireless communication, radar, vector operations, machine learning (ML)/AI applications, and the like. As such, the core 210 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 110. The hardware elements in the core 210 may change depending on the engine type. That is, the cores in an AI engine, digital signal processing engine, cryptographic engine, or FEC may be different.

The memory module 230 includes a DMA engine 215, memory banks 220, and hardware synchronization circuitry (HSC) 225 or other type of hardware synchronization block. In one embodiment, the DMA engine 215 enables data to be received by, and transmitted to, the interconnect 205. That is, the DMA engine 215 may be used to perform DMA reads and write to the memory banks 220 using data received via the interconnect 205 from the NoC or other DPEs 110 in the array.

The memory banks 220 can include any number of physical memory elements (e.g., SRAM). For example, the memory module 230 may be include 4, 8, 16, 32, etc. different memory banks 220. In this embodiment, the core 210 has a direct connection 235 to the memory banks 220. Stated differently, the core 210 can write data to, or read data from, the memory banks 220 without using the interconnect 205. That is, the direct connection 235 may be separate from the interconnect 205. In one embodiment, one or more wires in the direct connection 235 communicatively couple the core 210 to a memory interface in the memory module 230 which is in turn coupled to the memory banks 220.

In one embodiment, the memory module 230 also has direct connections 240 to cores in neighboring DPEs 110. Put differently, a neighboring DPE in the array can read data from, or write data into, the memory banks 220 using the direct neighbor connections 240 without relying on their interconnects or the interconnect 205 shown in FIG. 2. The HSC 225 can be used to govern or protect access to the memory banks 220. In one embodiment, before the core 210 or a core in a neighboring DPE can read data from, or write data into, the memory banks 220, the core (or the DMA engine 215) requests a lock acquire to the HSC 225 when it wants to read or write to the memory banks 220 (i.e., when the core/DMA engine want to “own” a buffer, which is an assigned portion of the memory banks 220. If the core or DMA engine does not acquire the lock, the HSC 225 will stall (e.g., stop) the core or DMA engine from accessing the memory banks 220. When the core or DMA engine is done with the buffer, they release the lock to the HSC 225. In one embodiment, the HSC 225 synchronizes the DMA engine 215 and core 210 in the same DPE 110 (i.e., memory banks 220 in one DPE 110 are shared between the DMA engine 215 and the core 210). Once the write is complete, the core (or the DMA engine 215) can release the lock which permits cores in neighboring DPEs to read the data.

Because the core 210 and the cores in neighboring DPEs 110 can directly access the memory module 230, the memory banks 220 can be considered as shared memory between the DPEs 110. That is, the neighboring DPEs can directly access the memory banks 220 in a similar way as the core 210 that is in the same DPE 110 as the memory banks 220. Thus, if the core 210 wants to transmit data to a core in a neighboring DPE, the core 210 can write the data into the memory bank 220. The neighboring DPE can then retrieve the data from the memory bank 220 and begin processing the data. In this manner, the cores in neighboring DPEs 110 can transfer data using the HSC 225 while avoiding the extra latency introduced when using the interconnects 205. In contrast, if the core 210 wants to transfer data to a non-neighboring DPE in the array (i.e., a DPE without a direct connection 240 to the memory module 230), the core 210 uses the interconnects 205 to route the data to the memory module of the target DPE which may take longer to complete because of the added latency of using the interconnect 205 and because the data is copied into the memory module of the target DPE rather than being read from a shared memory module.

In addition to sharing the memory modules 230, the core 210 can have a direct connection to cores 210 in neighboring DPEs 110 using a core-to-core communication link (not shown). That is, instead of using either a shared memory module 230 or the interconnect 205, the core 210 can transmit data to another core in the array directly without storing the data in a memory module 230 or using the interconnect 205 (which can have buffers or other queues). For example, communicating using the core-to-core communication links may use less latency (or have high bandwidth) than transmitting data using the interconnect 205 or shared memory (which requires a core to write the data and then another core to read the data) which can offer more cost effective communication. In one embodiment, the core-to-core communication links can transmit data between two cores 210 in one clock cycle. In one embodiment, the data is transmitted between the cores on the link without being stored in any memory elements external to the cores 210. In one embodiment, the core 210 can transmit a data word or vector to a neighboring core using the links every clock cycle, but this is not a requirement.

In one embodiment, the communication links are streaming data links which permit the core 210 to stream data to a neighboring core. Further, the core 210 can include any number of communication links which can extend to different cores in the array. In this example, the DPE 110 has respective core-to-core communication links to cores located in DPEs in the array that are to the right and left (east and west) and up and down (north or south) of the core 210. However, in other embodiments, the core 210 in the DPE 110 illustrated in FIG. 2 may also have core-to-core communication links to cores disposed at a diagonal from the core 210. Further, if the core 210 is disposed at a bottom periphery or edge of the array, the core may have core-to-core communication links to only the cores to the left, right, and bottom of the core 210.

However, using shared memory in the memory module 230 or the core-to-core communication links may be available if the destination of the data generated by the core 210 is a neighboring core or DPE. For example, if the data is destined for a non-neighboring DPE (i.e., any DPE that DPE 110 does not have a direct neighboring connection 240 or a core-to-core communication link), the core 210 uses the interconnects 205 in the DPEs to route the data to the appropriate destination. As mentioned above, the interconnects 205 in the DPEs 110 may be configured when the SoC is being booted up to establish point-to-point streaming connections to non-neighboring DPEs to which the core 210 will transmit data during operation.

However, in other embodiments, the core-to-core communication links may be used even if the data is intended for non-neighboring cores (e.g., cores in DPEs that are separated from the transmitting core by at least one other DPE). For example, multiple segments of core-to-core communication links may be used to transmit data to multiple cores in a column or in a row.

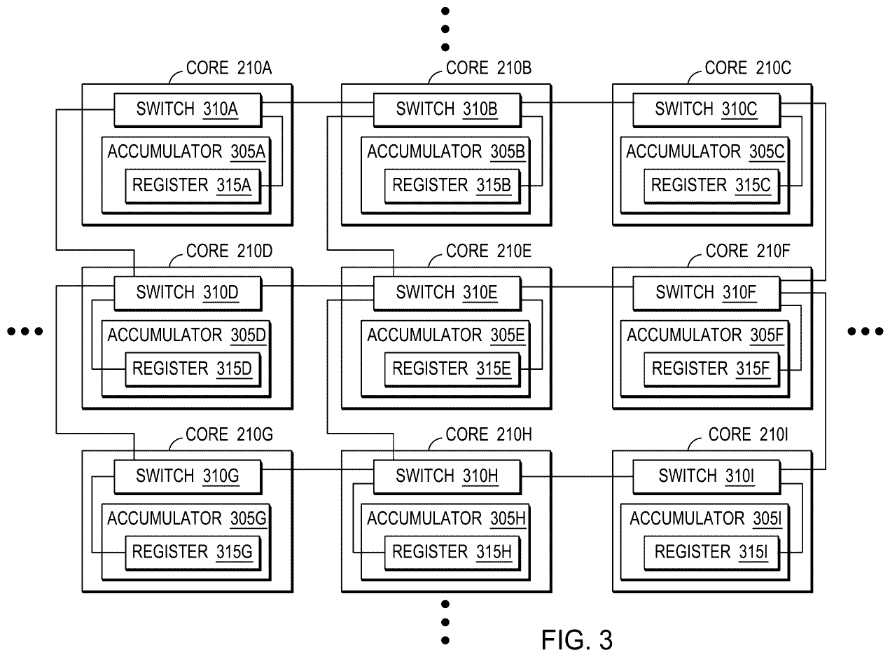

FIG. 3 is a block diagram of an accumulator broadcast network, according to an example. The accumulator broadcast network is an example of a network formed from the core-to-core communication links discussed above in FIG. 2. Although not shown in FIG. 3, the cores 210 can communicate using the other types of communication links and networks discussed in FIGS. 1 and 2, in addition to the accumulator broadcast network.

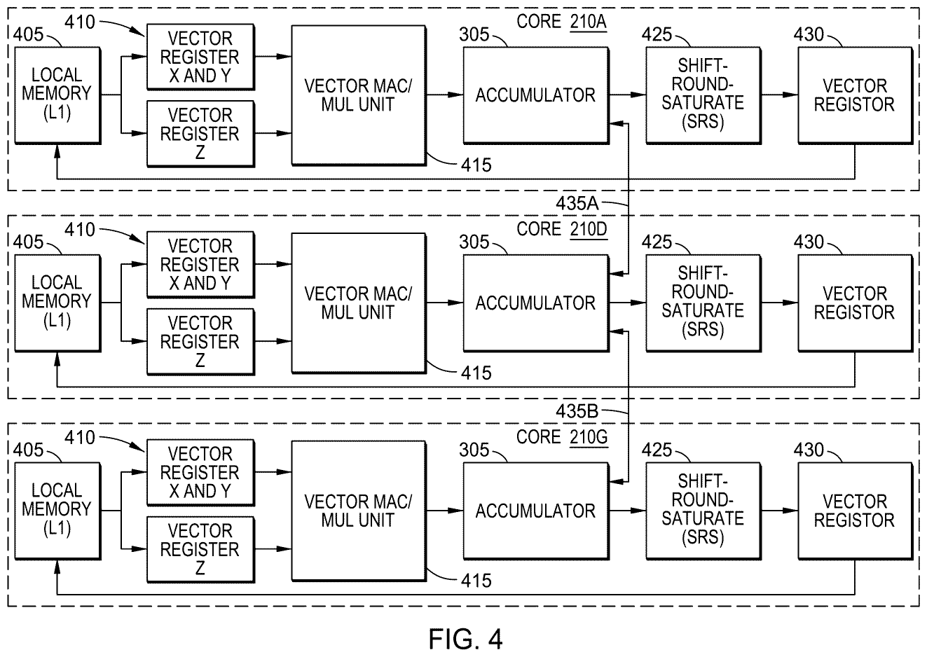

Each of the cores 210 (which can be in separate DPEs) includes an accumulator 305 and a switch 310. The accumulator 305 can perform MAC operations using lower precision inputs and generate higher precision intermediate results from accumulate operations in one or more accumulator registers 315. As discussed in more detail below in FIG. 4, once the MAC operation is finished, the results in the registers 315 may be rounded or bit shifted back to the lower precision value before the data is transferred out of the core 210.

Instead, FIG. 3 illustrates an accumulator broadcast network so that the higher precision data in the registers 315 can be transmitted directly to an accumulator 305 in another core 210. For example, a workload may be distributed across multiple cores 210 where the accumulators 305 perform different portions of the workload. It would be advantageous for the accumulators to share the higher precision intermediate data stored in the registers 315 (referred to as intermediate results). This can increase the accuracy of the distributed operation, as well as avoid the extra latency and cycles used if the data was transmitted between the cores 210 using indirect communication techniques (e.g., the interconnects 205 or the direct neighbor connections 240 for shared memory illustrated in FIG. 2).

The switches 310 are hardware (circuitry) in each of the cores 210 that are connected to switches 310 in neighboring cores using direct core-to-core links. For example, the switch 310E in core 210E is connected to the switch 310B (north), switch 310F (east), switch 310H (south), and switch 310D (west). The switch 310E is also connected to the local accumulation register 315E. In one embodiment, each switch 310 is connected to switches 310 in four neighboring cores unless the cores are disposed along an edge of the array, in which case those switches may be connected to the switches in three or two neighboring cores, depending on their location along the edge of the array. However, in other embodiments, the switches 310 may not be fully connected to the neighboring cores.

In one embodiment, the connections between the switches 310 are direct connections (e.g., direct core-to-core links or direct core-to-core segments). Rather than using these direct connections to transmit data only between neighboring cores 210, the switches permit the cores 210 to transmit data to non-neighboring cores 210. For example, the core 210D can transmit data to the core 210C by transmitting data to the switch 310E in core 210E, which forwards the data to the switch 310F (or switch 310B), which forwards the data to the switch 310C which then stores the data in the registers 315C. Thus, the switches 310 enable data to be routed to any of the cores 210 in the array, whether neighboring or not.

In one embodiment, the switches 310 are configured at compile time by a compiler. For example, the switches 310 can have configuration registers which set the control signals in the switch 310 so that data is routed to the desired core during operation. In other embodiments, the switches 310 are configured at runtime by applications (e.g., software) executed on the cores 210 which can program the switches 310 to forward data along the desired broadcast path(s).

The switches 310 can be implemented using different hardware circuitry or configurations. In one embodiment, the switches 310 are switchboxes that are configurable to selectively route the data to the other switches. In one embodiment, the switches 310 are implemented using a plurality of multiplexers where the selection signals can be set to selectively route the data.

In addition to routing accumulator data to neighboring and non-neighboring cores 210, the switches 310 can enable a core to broadcast data to multiple cores 210 simultaneously. For example, the core 210D may want to transmit data in its accumulation register 315D to core 210E and 210F (in the same row). To do so, the core 210D can use the switch 310D to transmit data to the switch 310E which is configured to store the data in the accumulation register 315E as well as forward the data to the switch 310F in the core 210F. The switch 310F then stores the data in the register 315F. In another example, the core 210F may want to transmit the data stored in its register 315E to the core 210B and core 210H (in the same column). To do so, the core 210E can use the switch 310E to transmit data to the switch 310B and the switch 310H in parallel. The switches 310B and 310H then store the data in the accumulation registers 315B and 315H.

In addition to broadcasting data to the cores in the same row or column, the accumulation broadcast network can be used to broadcast data in different rows and columns. For example, the core 210E may want to broadcast the data in the register 315E to the core 210C and the core 210G. To do so, the switch 310E can transmit the data to the switch 310F which forwards the data to the switch 310C which stores the data in the accumulation register 315C. Note, in this example, the switch 310F does not store the data in its local register 315F and only forwards the data. In parallel, the switch 310E transmits the data to the switch 310H which forwards the data to the switch 310G which stores the data in the accumulation register 315G. Note, in this example, the switch 310G does not store the data in its local register 315G and only forwards the data. In this manner, the switches 310 enable a core 210 to selectively transmit accumulator data to any number of the cores in the array which can be located in any row or column.

FIG. 4 is a block diagram of connections between accumulators in different cores, according to an example. FIG. 4 illustrates one of the columns in FIG. 3 which includes the cores 210A, 210B, and 210C. FIG. 4 illustrates one example implementation of the cores 210, which includes local memory 405, vector registers 410, a vector MAC/multiply unit 415, the accumulator 305, shift-round-saturate (SRS) 425, and a vector register 430.

The local memory 405 can store data which is then loaded into the vector registers 410 that serve as inputs to the vector MAC/multiply unit 415. The results of the multiply operation performed by the unit 415 is then stored in the accumulator 305, where it is accumulated from (added to) results from previous iterations. As such, the registers in the accumulator 305 (not shown) may store data at higher precision than the data in the vector registers 410. For example, the input data may be 8-bits or 16-bits but the accumulator registers may store 32-bit or 64-bit data.

Because of this, the SRS 425 (one example of rounding circuitry) may bit shift or round the data stored into the accumulator to reduce its precision so it again matches the precision of the data stored in the local memory 405. That is, the SRS 425 can convert the higher-precision data stored in the accumulator 305 into lower precision data stored in the local memory 405. This data is stored in the vector register 430, which can in turn store the data in the local memory 405.

FIG. 4 illustrates core-to-core links 435A and 435B for transmitting data between the cores 210A-C. In the example illustrated in FIG. 4, the core 210D transmits data from its accumulator to the accumulators in cores 210A and 210G in parallel. Doing so allows the cores 210 to exchange accumulated data before the data passes through the SRS 425 where its precision is reduced. That is, to transmit the data to the cores without the core-to-core links, the data would have to first pass through the SRS 425 and be stored in the vector register 430 and the local memory 405. This lower precision data could then be exchanged using the streaming interconnect, or shared memory techniques discussed above in FIGS. 1 and 2.

Although not shown, the core-to-core links 435A and 435B could include switches or some other hardware circuitry to enable a broadcast. In another embodiment, software may control the core-to-core links 435A and 435B. For example, assume that core 210A wants to broadcast the data stored in its accumulator 305 to both core 210D and core 210E. The core 210D first receives the data from the core 210A using the link 435A and then uses one or more processing cycles to forward the data to the core 210G. Once the data is forwarded, the core 210D can then process the data using its accumulator. Thus, while using software to broadcast data to subsequent cores 210 can avoid hardware such as the switches, it takes processing time for the cores 210 to forward the data before they can begin to process the received data. Nonetheless, both approaches can be used to implement an accumulation broadcast network.

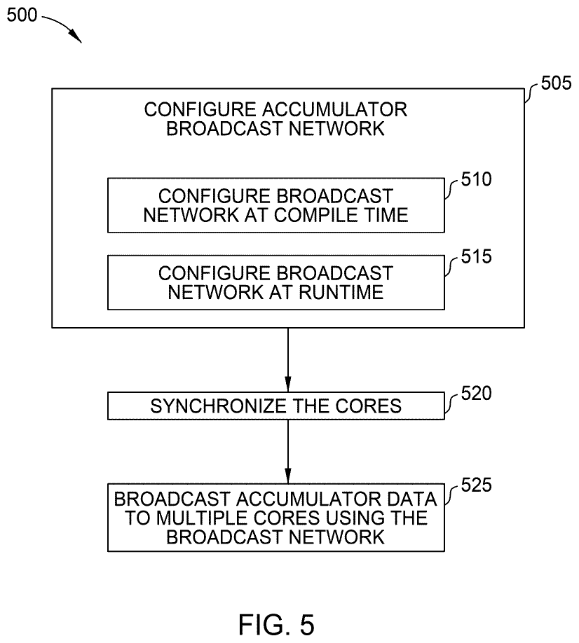

FIG. 5 is a flowchart of a method 500 for communicating directly between accumulators in different cores, according to an example. At block 505, the IC configures the accumulator broadcast network. If the accumulator broadcast network includes switches (e.g., a switchbox or a plurality of multiplexers), at block 505 the IC can set control register or select lines to establish the paths used to broadcast data between the accumulators in different cores.

There are two different techniques for configuring the broadcast network. At sub-block 510, the broadcast network can be configured at compile time where a compiler updates the control registers or signals in the switches to establish the paths used to broadcast the accumulator data during operation.

Alternatively, at sub-block 515, the broadcast network is configured at runtime by applications (e.g., software) executing on the cores. For example, the applications may instruct the cores how to configure their respective switches in order to establish the paths used to broadcast the accumulator data.

At block 520, the cores are synchronized before transmitting data using the accumulator broadcast network. If the cores are not synchronized, then a core may not be ready for the data it receives from another core. In that case, the core could stall if the data is not buffered. Instead, the cores could be synchronized so that a stall is avoided, and the received accumulator data does not have to be buffered.

The embodiments herein are not limited to any particular technique for synchronizing the cores. In one embodiment, the core that receives the data could wait until the data arrives so that when the data does arrive, the core is ready to process the data. In another embodiment, the transmitting core can send a message to the destination cores asking if they are ready for the data. When the cores reply indicating they are ready, the transmitting core can then transmit the accumulator data to the cores.

At block 525, a core broadcasts the accumulator data to multiple cores using the accumulation broadcast network. As discussed above, the multiple cores may be disposed on the same row, or on the same column, as the transmitting core. In another embodiment, the multiple cores may be disposed on different rows or columns.

In one embodiment, the multiple cores that receive the data may be neighbors of the transmitting core in the array. However, in another embodiment, at least one of the multiple cores may not be a neighbor of the transmitting core in the network while another one of the multiple cores is a neighbor. In yet another embodiment, each of the cores receiving the data may be non-neighbor cores of the transmitting core in the array.

Further, the accumulator data can be broadcast using hardware switches in the cores (e.g., the switches 310 in FIG. 3). However, to reduce space, the cores themselves can be used to forward the accumulator data. In that case, a core receiving the data can use processing cycles to forward the accumulator data to another core (and then process the data if it is a destination of the data), which means the switches can be omitted from the accumulator broadcast network.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) comprising:
an array of data processing engines (DPEs), each comprising a core, wherein each of the cores comprises an accumulator; and
an accumulator broadcast network comprising direct core-to-core links that interconnect the accumulators in the cores,
wherein a first core of the cores is configured to use the accumulator broadcast network to transmit accumulator data to multiple cores in parallel.

2. The IC of claim 1, wherein the multiple cores are neighbors to the first core in the array of DPE.

3. The IC of claim 1, wherein at least one of the multiple cores is a non-neighbor to the first core in the array of DPEs.

4. The IC of claim 3, wherein the multiple cores are in a same row or a same column as the first core.

5. The IC of claim 1, wherein a first one of the multiple cores is in a different column and different row in the array of DPEs as a second one of the multiple cores.

6. The IC of claim 1, wherein each of the DPEs comprises a switch that is connected to multiple ones of the direct core-to-core links.

7. The IC of claim 1, wherein each of the cores comprises a vector register, wherein data stored in the vector register is lower precision than the data transmitted on the accumulator broadcast network.

8. The IC of claim 7, wherein each of the cores comprises rounding circuitry configured to convert higher-precision data generated by the accumulators into lower precision data that is stored in the vector registers, wherein the direct core-to-core links receive the accumulator data from the accumulators before the accumulator data is rounded by the rounding circuitry.

9. The IC of claim 1, wherein the first core and the multiple cores are synchronized before the first core transmits the accumulator data so that the multiple cores are ready to process the accumulator data with respective accumulators.

10. The IC of claim 1, wherein the first core is configured to process the accumulator data with its accumulator to perform a portion of a multiply-accumulate (MAC) operation, wherein the accumulator data is intermediate results of the MAC operation, and
wherein the multiple cores are configured to process the accumulator data with their accumulators to perform other portions of the MAC operation.

11. A method comprising:
configuring an accumulator broadcast network in an IC, the IC comprising an array of data processing engines (DPEs), each comprising a core, wherein each of the cores comprises an accumulator, and wherein the accumulator broadcast network comprises direct core-to-core links that interconnect the accumulators in the cores;
synchronizing a first core of the cores to multiple cores of the cores; and
broadcasting accumulator data from the first core to the multiple cores in parallel using the accumulator broadcast network.

12. The method of claim 11, wherein the multiple cores are neighbors to the first core in the array of DPEs.

13. The method of claim 11, wherein at least one of the multiple cores is a non-neighbor to the first core in the array of DPEs.

14. The method of claim 13, wherein the multiple cores are in a same row or a same column as the first core.

15. The method of claim 11, wherein a first one of the multiple cores is in a different column and row in the array of DPEs as a second one of the multiple cores.

16. The method of claim 11, further comprising, before broadcasting the accumulator data, processing the accumulator data in the first core using its accumulator as part of performing a portion of a MAC operation, wherein the accumulator data is intermediate results of the MAC operation,
after broadcasting the accumulator data, processing the accumulator data with the accumulators in the multiple cores to perform other portions of the MAC operation.

17. The method of claim 11, wherein configuring the accumulator broadcast network comprises:
configuring, using a compiler, switches in the DPEs to establish broadcast paths in the accumulator broadcast network at compile time.

18. The method of claim 11, wherein configuring the accumulator broadcast network comprises:
configuring, using software executing on the first core and multiple core, switches to establish a broadcast path for the accumulator data in the accumulator broadcast network at runtime.

19. The method of claim 11, wherein broadcasting the accumulator data comprises:
using hardware switches in the DPEs to forward the accumulator data to the multiple cores.

20. The method of claim 11, wherein broadcasting the accumulator data comprises:
using processing cycles in at least one of the multiple cores to forward the accumulator data to another one of the multiple cores without using a switch.
